(19) United States
(12) Patent Application Publication
(10) Pub. No.: US 2001/0003281 A1
(43) Pub. Date: Jun. 14, 2001

(54) COMBUSTION CHAMBER FOR DIRECT INJECTION ENGINE

(76) Inventors: KENJI MORI, SHIZUOKA-KEN (JP); NAOKI TSUCHIDA, SHIZUOKA-KEN (JP); HIROYUKI TSUZUKU, SHIZUOKA-KEN (JP)

Correspondence Address: ERNEST A. BEUTLER, ATTORNEY AT LAW, 500 NEWPORT CENTER DRIVE, SUITE 945, NEWPORT BEACH, CA, 92660, US

(21) Appl. No.: 09/340,339

(22) Filed: Jun. 25, 1999

(30) Foreign Application Priority Data
Jun. 26, 1998 (JP) 10-180463
Jun. 30, 1998 (JP) 10-184851

(51) Int. Cl. F02B 17/00

(52) U.S. Cl. 123/305

(57) ABSTRACT

Several embodiments of direct injected spark ignited internal combustion engines. In these embodiments, the fuel injector is positioned quite close to the cylinder bore axis so as to ensure a homogeneous mixture in the combustion chamber under all running conditions and particularly high speed high load conditions. The injector in each embodiment is positioned, however, relative to this spark plug or plugs so that fuel will not be sprayed into their gap to cause fouling. In addition, an improved arrangement for showing heat transfer from both the spark plugs and fuel injectors to the engine coolant is also disclosed.

### BACKGROUND OF THE INVENTION

This invention relates a to a combustion chamber for a direct injected engine and more particularly to an improved layout for the fuel injector and spark plugs of such an engine that will improve engine performance.

Fuel injection has been recognized as a way in which the performance of an engine can be significantly improved both in terms of controlling exhaust emissions, improving fuel economy and also increasing the output of the engine, particularly under more widely varying conditions. Although manifold injection offers some of these advantages, direct cylinder injection offers even greater possibilities.

However, there are certain problems in connection with the utilization of direct cylinder injection. Not the least of these is the positioning of the fuel injector in a location wherein the fuel mixture can be adequately distributed within the combustion chamber. The injector position and spray pattern also should be such as to avoid impingement of fuel on the surfaces of the combustion chamber. Such deposited fuel may be difficult to ignite and completely burn. Thus high hydrocarbons may be present in the exhaust.

There is disclosed an arrangement in U.S. Pat. No. 5,799,638 entitled “Directional Injection System For Multi-Valve Engine”, issued Sep. 1, 1998, and assigned to the assignee hereof wherein the fuel injector and spark plug are positioned in proximity to each other and in close proximity to the center of the combustion chamber. Such an arrangement has considerable advantages.

By centrally positioning the spark plug, it can be ensured that there will be good flame propagation throughout the entire combustion chamber and that the mixture will be completely burned. The central positioning of the fuel injector also permits the disposition of fuel and its injection in a manner so that minimum contact of fuel with the combustion chamber walls.

However, the arrangement shown in that patent places the fuel injector in a location wherein some of the spray is directed at the spark plug. This is done to achieve stratification and for other purposes. However, when the fuel is sprayed directly toward the spark plug, there is a risk of plug wetting and fouling. In addition, although some stratification may be desirable, if the fuel is too highly stratified then high speed performance can be significantly deteriorated and hydrocarbon emissions under higher load conditions may become undesirable.

It is, therefore, a principal object of this invention to provide an improved combustion chamber configuration for a direct injected engine.

It is another object of this invention to provide a combustion chamber configuration for a direct injected engine wherein good fuel dispersion throughout the combustion chamber with minimum impingement on the cylinder walls and the spark plugs is assured.

Another problem associated with the positioning of the fuel injector and the spark plug in the central portion of the cylinder is that it greatly complicates the cylinder head configuration. This is particularly true when the engine employs multiple valves, which are also desirable to improve engine performance.

It is, therefore, a still further object of this invention to provide an improved cylinder head configuration that permits the use of multiple valves and a centrally positioned fuel injector without interfering with the valve actuation and the valve actuating mechanism.

A further problem in connection with the cylinder head mounting of both the fuel injector and the spark plug is the adequate cooling of these components. Cylinder heads are normally formed as castings and it is difficult at times to provide the desired cooling jacket arrangement in cast assemblies. This is particularly true with multi-valve, direct injected engines.

It is, therefore, a still further object of this invention to provide an improved arrangement for a cylinder head wherein adequate cooling is provided for either or both of the fuel injector and the spark plug.

### SUMMARY OF THE INVENTION

This invention is adapted to be embodied in a cylinder head arrangement for an internal combustion engine and combustion chamber configuration therefore. A cylinder head, cylinder block assembly is comprised of a cylinder bore closed at one end by a surface of the cylinder head to define a combustion chamber along with a piston that reciprocates in the defined cylinder bore. At least a pair of intake valve seats are formed on one side of a plane containing the axis of the cylinder bore and at least a pair of exhaust valve seats are formed on the other side of this plane in the cylinder head surface. A spark plug and fuel injector are mounted in the cylinder head and project through the combustion chamber surface thereof.

In accordance with a first feature of the invention, the spark plug is positioned in a location so that its spark gap is disposed vertically above the discharge nozzle of the fuel injector. This insures that fuel sprayed from the fuel injector will be directed away from rather than toward the spark plug gap.

In accordance with another feature of the invention, the cylinder head assembly is formed with an enlarged cooling jacket and at least one tubular member extends through this cooling jacket and receive at least one of the spark plug and fuel injector so as to promote heat transfer from the received element into the coolant in the cooling jacket.

### BRIEF DESCRIPTION OF THE DRAWINGS

FIG. 1 is a cross-sectional view taken through a cylinder of an internal combustion engine constructed in accordance with an embodiment of the invention and passing through the centers of one of the exhaust valves and one of the intake valves of the engine.

FIG. 2 is a cross-sectional view of the same cylinder taken along a plane that extends parallel to the plane of FIG. 1 and which contains the axis of the cylinder bore.

FIG. 3 is a bottom plan view of the cylinder head of this embodiment.

FIG. 4 is a cross-sectional view taken along a plane the same as that of FIG. 1 but shows a second embodiment of the invention.

FIG. 5 is a cross-sectional view in part similar to FIG. 2, but for the embodiment shown in FIG. 4.

FIG. 6 is a cross-sectional view, in part similar to FIG. 1 and for and shows a third embodiment of the invention.

FIG. 7 is an enlarged cross-sectional view which is in part similar to FIG. 2 but for the third embodiment and also looking in the opposite direction.

FIG. 8 is a cross-sectional view taken along a plane perpendicular to the planes of FIGS. 6 and 7 and containing the cylinder bore axis.

FIG. 9 is a bottom plan view of the cylinder head of the third embodiment and thus is in part similar to FIG. 3.

### DETAILED DESCRIPTION OF THE PREFERRED EMBODIMENTS OF THE INVENTION

Each embodiment will be described in conjunction with only a single cylinder of an engine and even that single cylinder will not be depicted completely in all views. The reason for this is that the invention deals primarily with a combustion configuration of each embodiment. Therefore, those skilled in the art will readily understand from the following descriptions of those portions of the engine that define the combustion chambers how to apply the concepts to engines having a wide variety of cylinder numbers and cylinder placements.

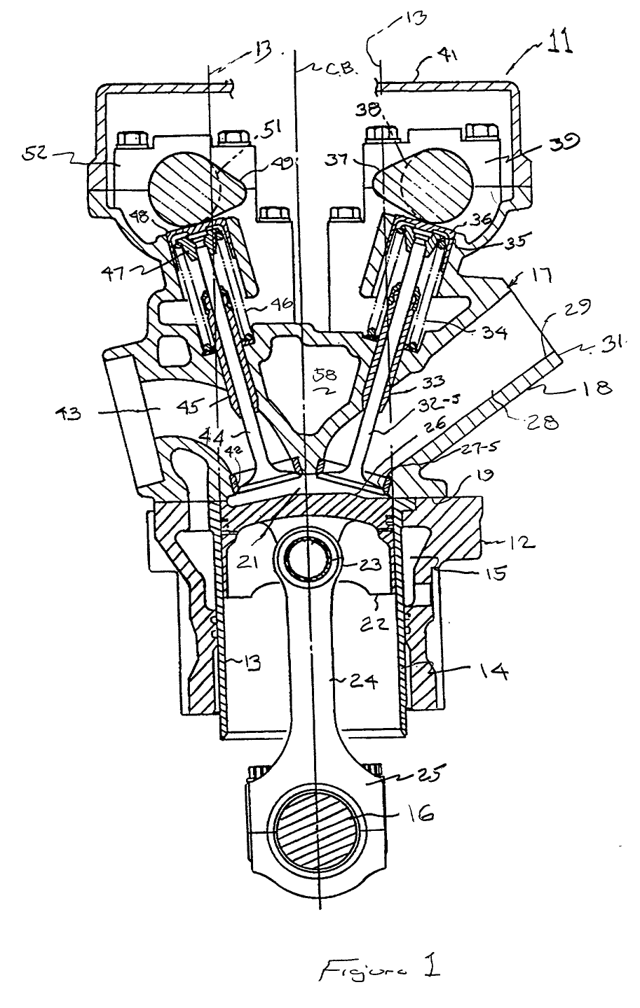

### Embodiment of FIGS. 1-3

An internal combustion engine constructed in accordance with a first embodiment of the invention is shown in these figures and is identified generally by the reference numeral 11. The engine 11 includes a cylinder block 12 that has a cylinder bore 13 formed by a liner 14 that may be inserted or cast in place within the cylinder block 12 with a water jacket 15 there around for cooling purposes.

The cylinder block 12 is connected in a suitable manner to a crankcase assembly, which is not shown for the aforenoted reasons, and in which a crankshaft 16 rotates about a longitudinally extending axis. The crankshaft axis is intersected by the axis C.B. of the cylinder bore 13.

A cylinder head assembly, indicated generally by the reference numeral 17, is fixed relative to the cylinder block 12 in appropriate manner. In fact, the cylinder head assembly 17 may include a cylinder head member that is formed integrally with the cylinder block 12 if desired.

The cylinder head assembly 17 includes a main cylinder head member 18 that has a surface 19 that is in sealing engagement with the cylinder block 12 around the cylinder bore 13. A suitable gasket or other sealing arrangement may be provided to achieve this sealing if a unitary assembly is not employed.

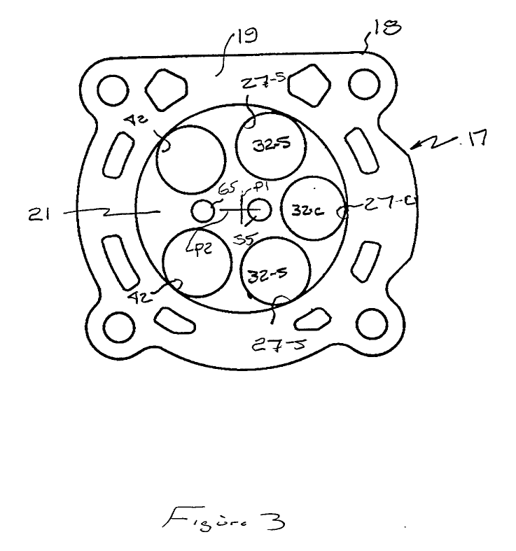

The cylinder head surface 19 surrounds a recessed surface area 21 which forms in part the combustion chamber of the engine. This recessed area 21 has a configuration as is best shown in FIG. 3.

A piston 22 reciprocates within the cylinder bore 13 and is connected by means of a piston pin 23 to the upper or small end of a connecting rod 24 The connecting rod 24 has a big end 25 journaled on a throw of the crankshaft 16 in a well known manner.

In the illustrated embodiments, the head of the piston 22 may be either planar or formed with a slight dome 26. Since the engine 11 is not designed primarily for operation on a stratified principal, it is now necessary to form a bowl in the head of the piston although certain features of the invention may also be employed with stratified engines.

The cylinder head surface 21 is formed with a plurality of intake ports or intake valve seats, indicated generally by the reference numeral 27. These intake valve seats 27 are comprised of a pair of side intake valve seats 27-S and a center intake valve seat 27-C. Basically, all of the intake valve seats 27 lie in major portion on one side a plane that contains the cylinder bore axis C.B., although the side intake valve seats 27-S may extend slightly over this plane. This plane also contains the axis of rotation of the crankshaft 16.

For a reason to be described, the diameter of the center intake valve seat 27-C may be made smaller than that of the side intake valve seats 27-S.

The intake valve seats 27 are formed at the discharge end of an intake passage arrangement 28 that is formed in the cylinder head member 18 and which extends from an inlet opening 29 formed in an outer surface 31 thereof. Any suitable form of induction system may be employed for delivering an air charge to the cylinder head intake passage arrangement 28. In the illustrated embodiments, the intake passages 28 are of the Siamesed type but the invention can obviously be utilized with individual passages for each intake valve seat or any type of paired arrangement.

These intake valve seats 27 are valved by the heads of poppet type intake valves 32. The stems of these intake valves 32 are slidably supported in valve guides 33 pressed or cast into the cylinder head member 18. Coil compression spring assemblies 34 act against a surface of the cylinder head member 18 and keeper retainer assemblies 35 for urging these poppet take intake valves 32 to their closed positions.

The intake valves 32 are open by means that includes thimble type tappets 36 that are slidably supported in the cylinder head member 18 and engaged with the lobes 37 of an intake cam shaft 38. The intake cam shaft 38 is journaled in the cylinder head member 18 by bearing surfaces formed integrally therein and by bearing caps 39 which are affixed thereto. The intake cam shaft 38 is driven at one half crankshaft speed by any suitable valve timing mechanism.

The valve mechanism thus far described is contained within a cam chamber formed at the upper end of the cylinder head assembly 17 and which is closed by a cam cover 39 that is affixed to the cylinder head member 18 in any suitable manner.

In addition to the air charge supplied by the intake passages 29 and valve seats 27 a fuel charge is delivered to the combustion chambers formed by the cylinder head recesses 21 by a fuel injection system which will be described shortly. This charge is then fired by spark plugs, which will also be described shortly.

The burnt charge is discharged from the combustion chambers through exhaust ports or exhaust valve seats 42 which are formed in the cylinder head surface 21 on the opposite side of the aforenoted plane that contains the cylinder bore axis CB. In the illustrated embodiment, there are two such exhaust ports or valve seats 42 per cylinder. These valve seats communicate with exhaust passages 43 that are formed in the cylinder head member 18 and which communicate with a suitable exhaust system (not shown) for discharge of the exhaust gases to the atmosphere.

Poppet type exhaust valves 44 have stem portions that are slidably supported in valve guides 45 that are pressed, cast or otherwise formed in the cylinder head member 18. Coil compression spring assemblies 46 act against surfaces of the cylinder head member 18 and keep a retainer assemblies 47 for urging the exhaust 44 to their closed position wherein their heads sealingly engage the exhaust valve seats or ports 42.

Thimble type tappets 48 are slidably supported in the cylinder head member 18 and are operated by the lobes 49 of an exhaust cam shaft 51. Like the intake cam shaft 38, the exhaust cam shaft 51 is journaled in the cylinder head member 18 by integral bearing surfaces formed thereon and bearing caps 52 that are affixed thereto.

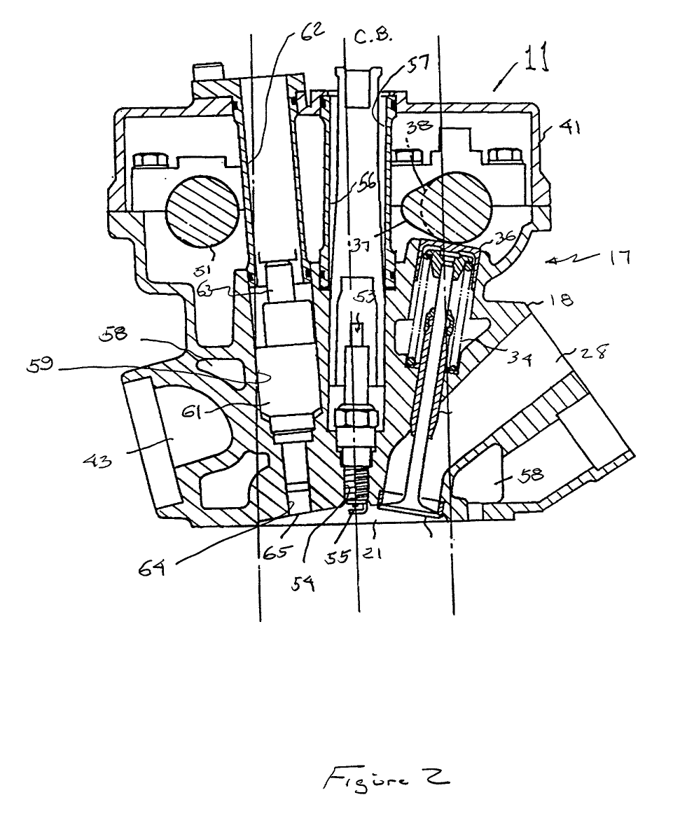

The exhaust cam shaft 51 is, like the intake cam shaft 38, driven at one half crankshaft speed by any suitable timing mechanism. The axes of rotation of the intake and exhaust cam shafts 38 and 51 lie generally outside of an extension of the cylinder bore axis 13 as best seen in FIG. 1. This is done to open up a relatively large area at the center of the cylinder head recess 21 so as to facilitate positioning of the spark plug and fuel injector, as will now be described by particular reference to FIGS. 2 and 3.

A spark plug, indicated generally by the reference numeral 53 is mounted in a threaded opening 54 formed in the cylinder head member 18 and has its spark gap 55 extending into the cylinder head recess 21. This spark gap 55 is disposed so that it lies substantially a plane that contains the cylinder bore axis CB and which extends perpendicularly to the aforenoted plane that divides the intake side of the cylinder head assembly 17 from the exhaust side thereof. This relationship appears in FIG. 3 wherein these two planes are indicated at P1 and P2 respectively with the spark gap lying on the plane P2 and positioned quite close to the plane P1. The reason for this will be described shortly. This is facilitated in part by the smaller diameter of the center intake valve seat 27-C and the head of the associated intake valve 32-C.

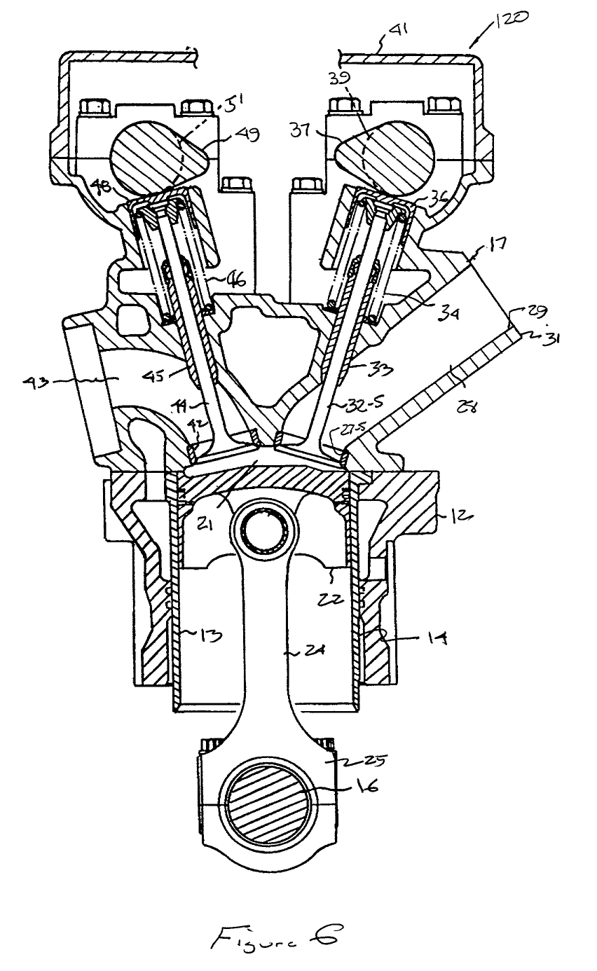

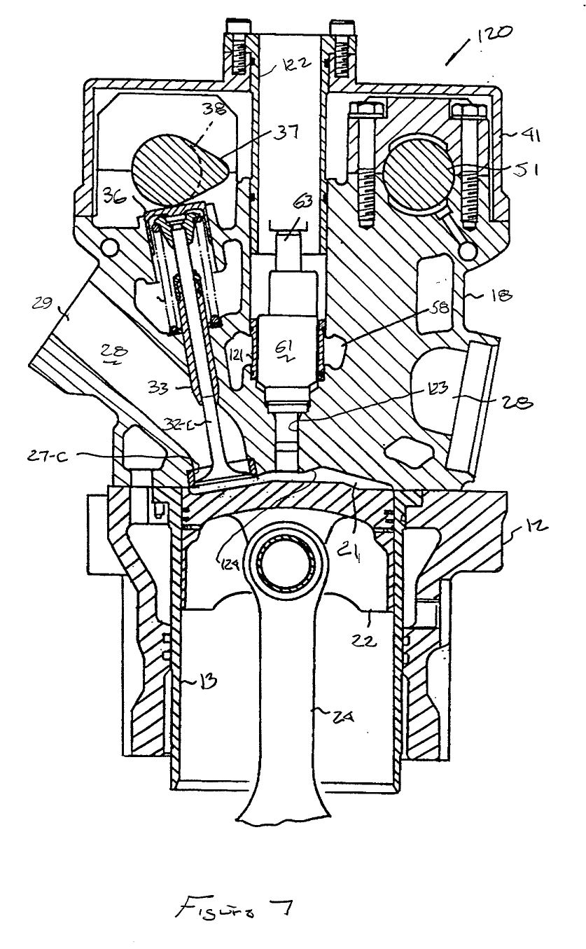

In this embodiment, the spark plug 55 is contained in part in a tubular member 56 that forms a spark plug well 57 generally centrally of the cylinder head assembly 17. In this embodiment, the tubular member 56 extends upwardly above a water jacket 58 that is formed in the cylinder head member 18 and which communicates with the cylinder block cooling jacket 15 in a suitable manner. As will be apparent from a description of the embodiment FIGS. 6-9, however, this tubular member 56 may actually pass through the cooling jacket 58 and be completely surrounded by it so as to facilitate cooling of the spark plug 53 as will be described in more detail by reference to those latter figures.

The cylinder head member 18 is also formed with a fuel injector receiving opening 59 in which a fuel injector, indicated generally by the reference numeral 61, is supported. A tubular member 62 extends upwardly above the cylinder head member 18 and passes electrical and fuel components for supplying electrical power to the fuel injector 61 and the fuel injection into the cylinder bore 13.

Like the spark plug tube 56, the fuel injector tube 62 may extend downwardly into the cylinder head member 18 so as to be completely surrounded by the cooling jacket 58, in the same manner as will be described later by reference to FIGS. 6-9 so as to further improve the cooling of the fuel injector 61.

The fuel supply for the fuel injector 61 may be of any known type and preferably includes at least a high pressure pump and fuel rail for delivering the fuel to a fuel inlet nozzle 63 of the fuel injector 61.

Below the injector receiving opening 59, there is performed in the cylinder head member 18 a further smaller diameter opening 64 through which the discharge nozzle 65 of the fuel injector 61 extends. It should be noted that the injector nozzle 65 is offset from the cylinder bore axis C.B. and is spaced further from the plane P1 than the spark plug 55.

Because of the dome shape of the recess 21, this means that the fuel injector discharge nozzle 65 and particularly the spray ports thereof are positioned vertically below the spark gap 55. This ensures that fuel that is sprayed from the injector 61 and specifically its nozzle 65 will not impinge upon the spark plug terminals that define the gap 55.

Also, the injector nozzle 65 is positioned close enough the cylinder bore axis CB so as to ensure that fuel will have minimum impact on the cylinder bore surface 13 and also on the head of the piston 22. Preferably, the fuel injection timing is such that fuel is injected during the intake stroke so that the fuel will be well mixed with the air that is delivered to get through the intake passage 28 and the intake valve seats or ports 27.

The fuel injector nozzle 65 is, as best seen in FIG. 3, however, disposed between the exhaust valve seats 22. This is because of the use of the three intake valves and only two exhaust valves. Thus, there is more available space on the exhaust side of the engine and this facilitates positioning of the fuel injector 61 on this side without interference with the valve actuating mechanism for the exhaust valves 44 and specifically the thimble tappets 48 and stem portions of the valves 44.

As may be best seen in FIG. 2, the axes of the spark plug 53 and fuel injector 66 are disposed at a relatively small acute angle relative to each other.

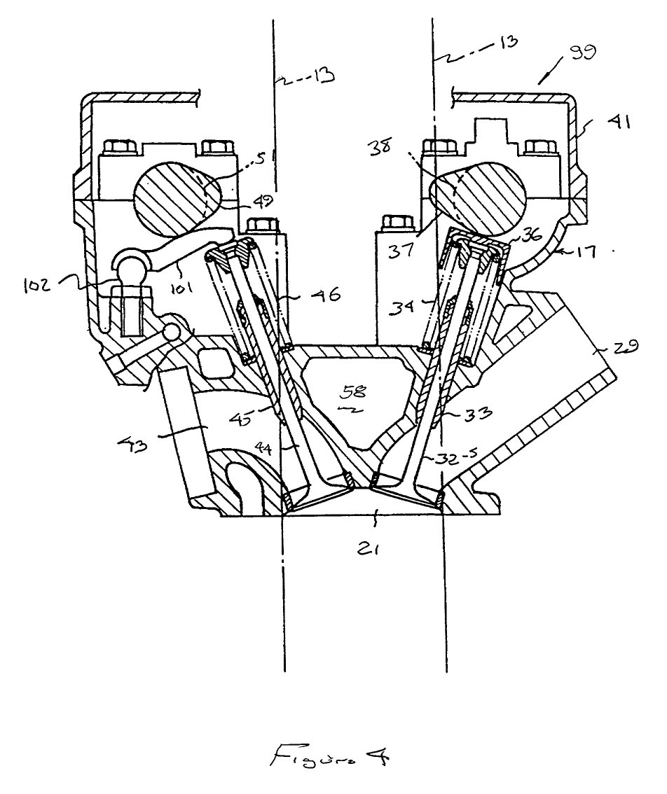

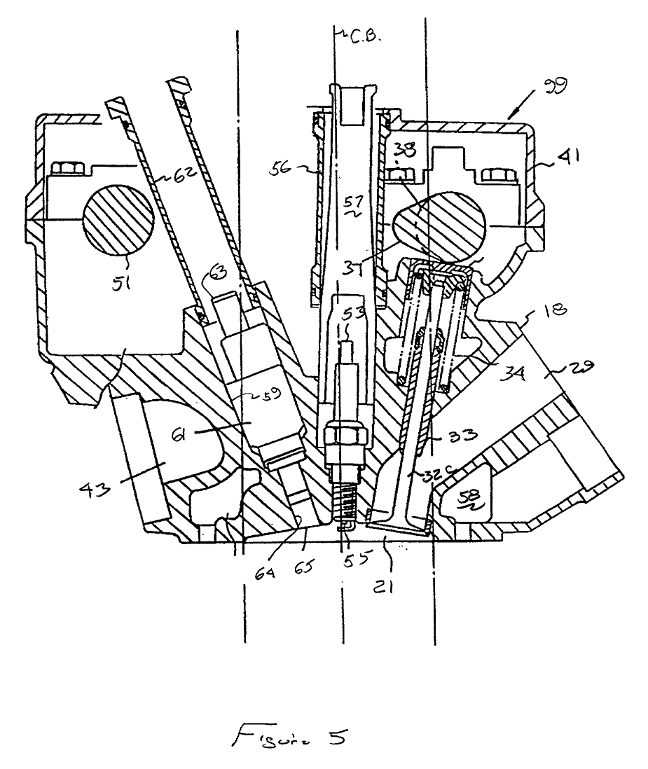

### Embodiments of FIGS. 4 and 5

FIGS. 4 and 5 show an engine 99 constructed in accordance with another embodiment of the invention which differs from the embodiment of FIGS. 1-3 only the positioning of the fuel injector 61 and the manner of operating the exhaust valves 44. For these reasons, only two views are believed to be necessary to illustrate this embodiment and where components of this embodiment are the same as those previously described except for their location or orientation, they have been identified by the same reference numerals and will not be described again, except insofar as to is necessary to understand the construction and operation of this embodiment.

In this embodiment, the well or opening 59 in the cylinder head member 18 that receives the main body portion 61 of the fuel injector and its corresponding nozzle receiving opening 64 are inclined at a greater acute angle to the spark plug 53 than the embodiment of FIGS. 1-3, as clearly shown in FIG. 5. Such a larger angle is desirable in view of the fact that the injector nozzle port 65 is offset from the cylinder bore axis C.B.

This angle is still relatively shallow, however, so that the fuel will not be sprayed toward the spark gap 55. However, because the injector nozzle port 65 is generally below the center terminal of the spark terminal 55 impingement is not likely. Thus, the fuel spray in this embodiment can be directed more toward the flow of intake air through the intake passages 28 and open intake valve seats 27 to improve the formation of a homogeneous fuel air mixture.

This mounting of the fuel injector 61 is facilitated by moving the rotational axis of the exhaust cam shaft 51 well outboard of the cylinder bore outer periphery 13 as a extended and as shown in FIG. 4. In order to permit this placement of the exhaust cam shaft 51 without increasing the angular orientation of the exhaust valves 44 excessively, rocker arms 101 are mounted on hydraulic tappets 102 and are operated by the exhaust cam lobes 49 for operating the exhaust valve 44.

As may be seen in FIG. 4, however, the exhaust valve 44 are more inclined from the cylinder bore axis CB in this embodiment than that of FIGS. 1-3 and this also facilitates this angular positioning of the fuel injector 61. In all other regards, this embodiment is the same as that previously described and further description is not believed to be necessary to permit those skilled in the art to practice the invention of this embodiment for that reason.

### Embodiment of FIGS. 6-9

FIGS. 6-9 show a third embodiment of the invention which is generally the same as those embodiments previously described. As was noted in the connection with the description of those embodiments, however, this embodiment employs an arrangement wherein the cooling for the fuel injector 61 and the spark plug 53 are greatly increased by having the tubular members that form their wells extend through the cylinder head cooling jacket 58.

Also, the engine, identified by the reference numeral 120, of this embodiment differs from the previously described embodiments in the positioning of the fuel injector 61 substantially on the cylinder bore axis CL. The fuel injector 61 is positioned in a well formed by a tubular member 121. This tubular member 121 passes directly through the cylinder head cooling jacket 58 so that heat transfer from the injector body 61 to the engine coolant can be significantly improved. A separate tubular member 122 is provided in the cylinder head member 18 and the cam cover 41 at the upper end of this fuel injector well although it is possible to join the members 121 and 122 into a single member.

The cylinder head 18 is formed with a bore 123 at the lower end thereof where the injector nozzle portion 65 of the fuel injector is received. In this embodiment, it will be seen that the cylinder head recess 21 is formed with a central projection 124 which is effective to lower the center of the combustion chamber recess 21 in this area for a reason which will become apparent shortly.

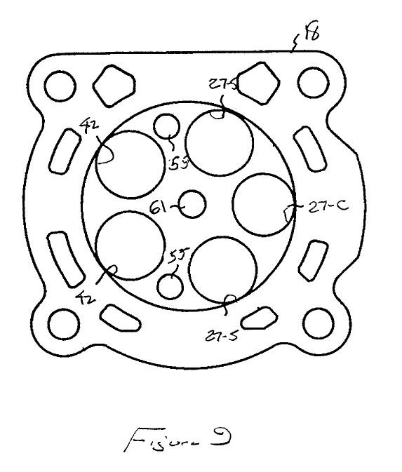

Since the fuel injector 61 is disposed substantially on the cylinder bore axis C.B., this means that the spark plug will be positioned off center. In order to ensure complete combustion and good flame propagation, therefore, there are provided a pair of spark plugs 53 that are threaded into tapped openings 125 that are formed on opposite sides of the cylinder bore 13 in the areas between the exhaust valve seats 42 and the side intake valve seat 27-S as clearly seen in FIG. 9.

This means that the spark gaps 55 of the spark plugs 53 are disposed at the peripheral portion of the combustion chamber but substantially equal distance from the cylinder bore axis C.B. Thus when the spark plugs 53 are fired it will be ensured that the complete charge in the combustion chamber will be ignited and burned completely. In this embodiment, the pair of combustion fronts will progress toward the cylinder bore axis C.B. rather than radially outwardly from it as in the previously described embodiment.

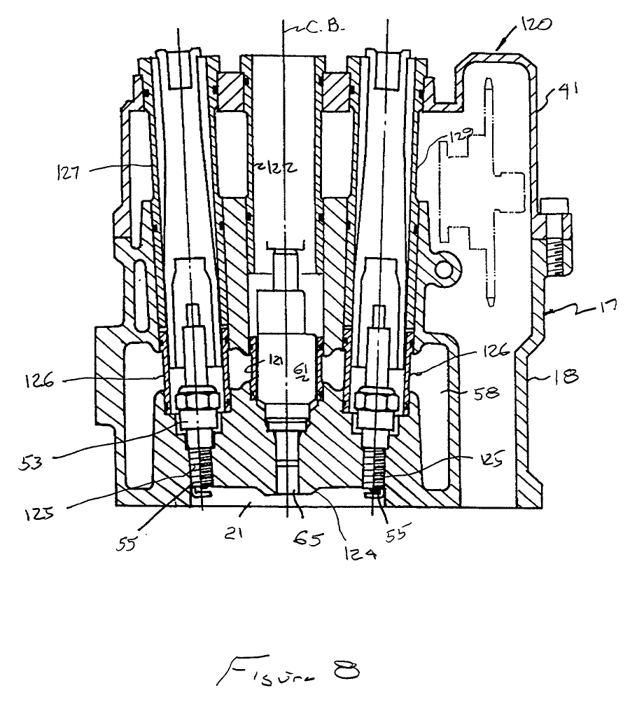

As best seen in FIG. 8, the projection 124 of the cylinder head recess 21 ensures that the injector nozzle tip 65 will be positioned no lower than the lowermost terminal of the spark terminals 55 so as to ensure against a fuel impingement on the spark gap 55.

In this embodiment, the spark plugs 55 are positioned in wells that are formed by tubular members 126 which extend directly through the cooling jacket 58 and hence, heat transfer from the spark plugs to the engine coolant will be promoted. These tubular members 126 are positioned below main spark plug tubes 127 that extend upwardly through the cam cover 41. As with the tubular members associated with the fuel injector, the tubular members 126 and 127 may be unitary with each other.

Thus, from the foregoing description it should be readily apparent that the described arrangement permit formation of a good and homogeneous fuel mixture in the combustion chamber and complete combustion. Since the spark plugs are positioned at a point that is not below the fuel injector nozzle, fuel will not impinge on the spark plug terminals to cause plug fouling. In addition, good heat transfer is provided. Of course, the foregoing description is that of preferred embodiments of the invention. Various changes and modifications may be made without departing from the spirit and scope of the invention, as defined by the appended claims.

1. A cylinder head arrangement for an internal combustion engine and combustion chamber configuration therefore, said arrangement comprising a cylinder head, cylinder block assembly comprised of a cylinder bore closed at one end by a surface of said cylinder head to define a combustion chamber along with a piston that reciprocates in said cylinder bore, at least a pair of intake valve seats formed in said cylinder head combustion chamber surface on one side of a plane containing the axis of said cylinder bore, at least a pair of exhaust valve seats are formed in said cylinder head combustion chamber surface on the other side of said plane, a spark plug and a fuel injector mounted in said cylinder head and projecting through said combustion chamber surface, said spark plug being positioned in a location so that its spark gap is disposed vertically above a discharge nozzle of said fuel injector for insuring that fuel sprayed from said fuel injector will be directed away from rather than toward said spark plug gap.

2. A cylinder head arrangement as set forth in claim 1 wherein the cylinder head combustion chamber surface has a dome shape and the spark plug is positioned higher in the dome than the fuel injector.

3. A cylinder head arrangement as set forth in claim 1 wherein the fuel injector and the spark plug are disposed in side by side relation.

4. A cylinder head arrangement as set forth in claim 3 wherein the fuel injector and the spark plug are disposed at acute angles to each other.

5. A cylinder head arrangement as set forth in claim 4 wherein the fuel injector and the spark plug are also disposed at acute angles to the cylinder bore axis.

6. A cylinder head arrangement as set forth in claim 5 wherein the acute angle of the fuel injector to the cylinder bore axis is greater than the acute angle of the spark plug to the cylinder bore axis.

7. A cylinder head arrangement as set forth in claim 1 wherein there are three intake valve seats comprised of a pair of spaced side intake valve seats closer to the plane than a center intake valve seat positioned generally between said side intake valve seats and two exhaust valve seats.

8. A cylinder head arrangement as set forth in claim 7 wherein the spark plug is between the side intake valve seats.

9. A cylinder head arrangement as set forth in claim 8 wherein the fuel injector is between the exhaust valve seats.

10. A cylinder head arrangement as set forth in claim 7 wherein the fuel injector is between the side intake valve seats.

11. A cylinder head arrangement as set forth in claim 10 wherein there are a pair of spark plug.

12. A cylinder head arrangement as set forth in claim 11 wherein each spark plug is disposed between a respective one of the side intake valve seats and an adjacent exhaust valve seat.

13. A cylinder head arrangement as set forth in claim 7 wherein all of the intake valves are operated by a single intake cam shaft journalled by the cylinder head on the one side of the plane containing the axis of the cylinder bore and all of the exhaust valves are operated by a single exhaust cam shaft journalled by the cylinder head on the other side of said plane.

14. A cylinder head arrangement as set forth in claim 13 wherein the spark plug is between the side intake valve seats and the fuel injector is between the exhaust valve seats.

15. A cylinder head arrangement as set forth in claim 14 wherein the fuel injector and the spark plug are disposed at acute angles to each other.

16. A cylinder head arrangement as set forth in claim 15 wherein the fuel injector and the spark plug are also disposed at acute angles to the cylinder bore axis.

17. A cylinder head arrangement as set forth in claim 16 wherein the acute angle of the fuel injector to the cylinder bore axis is greater than the acute angle of the spark plug to the cylinder bore axis.

18. A cylinder head arrangement as set forth in claim 17 wherein the exhaust cam shaft rotational axis is spaced further from the plane than the intake cam shaft rotational axis.

19. A cylinder head arrangement as set forth in claim 18 wherein the intake valves are directly operated by the lobes of the intake cam shaft.

20. A cylinder head arrangement as set forth in claim 19 wherein the exhaust valves are operated by the lobes of the exhaust cam shaft by rocker arms.

21. A cylinder head arrangement as set forth in claim 20 wherein the pivot axes of the rocker arms that operate the exhaust valves are further from the plane than the rotational axis of the exhaust cam shaft.

22. A cylinder head arrangement as set forth in claim 1 wherein the cylinder head is formed with a cooling jacket for liquid coolant and at least one tubular member extends through said cooling jacket and receives at least one of the spark plug and the fuel injector so as to promote heat transfer from the received element into the coolant in said cooling jacket.

23. A cylinder head arrangement as set forth in claim 22 wherein both of the spark plug and the fuel injector are received in tubular members that extend through the cooling jacket.

24. A cylinder head arrangement for an internal combustion engine and combustion chamber configuration therefore, said arrangement comprising a cylinder head, cylinder block assembly comprised of a cylinder bore closed at one end by a surface of said cylinder head to define a combustion chamber along with a piston that reciprocates in said cylinder bore, at least a pair of intake valve seats formed in said cylinder head combustion chamber surface on one side of a plane containing the axis of said cylinder bore, at least a pair of exhaust valve seats are formed in said cylinder head combustion chamber surface on the other side of said plane, a cooling jacket for liquid coolant formed in said cylinder head, a spark plug mounted in said cylinder head and projecting through said combustion chamber surface, a fuel injector mounted in said cylinder head and projecting through said combustion chamber surface, and at least one tubular member extending through said cooling jacket and receiving at least one of said spark plug and said fuel injector so as to promote heat transfer from the received element into the coolant in said cooling jacket.

25. A cylinder head arrangement as set forth in claim 24 wherein both of the spark plug and the fuel injector are received in tubular members that extend through the cooling jacket.
